(19) United States
(12) Patent Application Publication
(10) Pub. No.: US 2005/0064217 A1
(43) Pub. Date: Mar. 24, 2005

(54) Foldable bopp film suitable for fat packaging

(76) Inventors: Necdet Kileci, Gaziantep (TR); Hasan Camber, Gaziantep (TR); Fahri Ozer, Gaziantep (TR)

Correspondence Address: COLLEN IP, THE HOLYOKE MANHATTAN BUILDING, 80 SOUTH HIGHLAND AVENUE, OSSINING, NY, 10562, US

(21) Appl. No.: 10/497,110

(22) PCT Filed: Jan. 15, 2002
(86) PCT No.: PCT/TR02/00001

(30) Foreign Application Priority Data
Nov. 27, 2001 (TR) 2001/03415

(51) Int. Cl. B32B 27/32; B32B 5/16

(52) U.S. Cl. 428/516; 428/330

(57) ABSTRACT

The invention relates to a single or multi layer film with an improved barrier and dead-fold characteristic. More specifically, the present invention relates to a highly foldable and stiff film with single or multi layers for the packaging of food particularly margarine, butter or the like. The film developed in this invention is made up of the following layers. The base layer (C) and one of the outer layers (A) contain a homopolymer, a filler and a hydrocarbon resin. One of the inner layers (B) contains a homopolymer, a filler, a resin and a coloring agent, the other inner layer (D) contains a homopolymer and a resin and the second outer layer (E) contains a polymer mixture and an anti blocking agent.

The invention relates to a single or multi layer film with an improved barrier and dead-fold characteristic. More specifically, the present invention relates to a highly foldable and stiff film with single or multi layers for the packaging of food particularly margarine, butter or the like. The material used for packing must be a material which can be readily formed and good in mechanical strength, optical properties and oxygen and moisture barrier properties as well as a material which can be handled in fast moving horizontal or vertical packing equipment which packs the food.

In U.S. Pat. No. 5,224,737, it has been described that a thermoplastic nonwoven sheet used to form the casing for a hard cover book or the like. The sheet comprised between about 60% to about 85% by weight of polypropylene homopolymer, between about 12% to about 32% by weight of calcium carbonate and between about 3% to about 12% by weight of a polyolefin carrier, preferably linear low-density polyethylene. Even this material has proved excellent for hard cover books with its great folding characteristics; it was not a proper material for using in high speed packing machines.

U.S. Pat. No. 5,931,505 describes a book casing sheet, which can be folded. It is stated that the sheet is good in folding and compatibility in high-speed machines for making binder casings. The sheet comprises between about 30% and about 55% by weight of copolymer of propylene and ethylene; from 0% to about 12% by weight of polypropylene homopolymer, between 0% to about 20% by weight of high-density polyethylene, between about 23% and about 35% by weight of calcium carbonate or talc filler. It has been stated that this material is the first polypropylene sheet with both good folding and high speed machining characteristics. However this material is not suitable for packing the food products, which are susceptible to degradation due to the environmental conditions such as relative humidity and oxygen.

Biaxially oriented polypropylene (BOPP) films are widely used in packaging because they have good stiffness, mechanical strength, optical properties (low haze and high gloss) and moisture barrier properties. However, to date, it has been difficult to produce a foldable BOPP film, which will work with high-speed margarine packing machines. The material must be cutable and foldable to give the rectangular prism shape to the margarine.

BOPP films have been proposed to use in twist wrapping of various food products (DE-C-20 45 115; GB-A-1,231,861; EP-A-0 217 388). These films contain a low-molecular weight resin in order to achieve the desired twist properties. In EP 0 588 667 A2, it has been described that the hydrocarbon resin used to produce an oriented multilayer shrink film with an improved moisture barrier properties.

EP 0 544 652 A2 describes a film which was used for heat sealed packaging and twist wrapping. The film has been produced by blending polyolefine and a resin. The films produced by using resin (EP 0 288 227 and EP 0 247 898) have been also used for heat sealed packaging.

GB-A-2,055,688 describes a multilayer film, heat-sealable, biaxially oriented polypropylene film, which has good mechanical properties and good heat-sealing properties. The twist properties were improved by the addition of a resin with a molecular weight of about 1000 and also by biaxially stretching simultaneously.

GB-A-2,028,168 describes a heat-sealable biaxially oriented film. The film produced had very good mechanical properties. The mechanical properties such as twist properties were improved by the addition of the resin (1 to 50% by weight) with a molecular weight greater than 600, preferably 1000.

U.S. Pat. No. 4,921,749 describes a heat sealable biaxially oriented polypropylene film with improved optical and mechanical properties. A low molecular weight resin was used to improve the heat sealability and the water vapor and oxygen permeability characteristics. The resin (3 to 30% by weight) used had a molecular weight less than 1000.

CA2140464 describes a multilayer biaxially oriented polypropylene film containing hydrocarbon resin with a molecular weight particularly from 500 to 2000. It has been mentioned that the resin used in the film is a migrating one.

All the films mentioned above have been found to be not suitable for packaging the fats and fat containing foods because of the possible diffusion of the resins used through the film and migration into the food.

U.S. Pat. No. 6,060,139 describes a multilayer polypropylene film containing a resin which enables good twist behavior for twist wrapping and does not result in an increase in the concentration of resin in packaged fat-containing foods. As it is described above the films manufactured for the twist wrapping contain a resin, which is mainly used to improve dead fold properties of the films to make the film suitable for use as a twist film.

In the development of this present invention, two main problems have been aimed to be solved.

One aim of the present invention is to produce a single or multilayer film, which has good folding behavior for packing a rectangular shaped food product. At the same time, the film should have improved cutability, high mechanical strength, low coefficient of friction, and good stiffness at flat surfaces, optical properties and moisture and oxygen barrier properties. In addition to all these characteristics, it should be free from the production of cracking at the fold and low in grease permeation.

Second aim of the present invention is to provide a process for the production of the single or multilayer film by a co-extrusion process. The film manufactured should be used for packing the food specifically margarine, butter or the like.

The aims of the invention described above have been provided by a single or multilayer polypropylene film, which has at least one base layer. The multilayer films can be made with two or four inner and outer layers.

The five-layer film is made up of the following layers. The base layer (C) and one of the outer layers (A) contain a homopolymer, a filler and a hydrocarbon resin. One of the inner layers (B) contains a homopolymer, a filler, a resin and a coloring agent, the other inner layer (D) contains a homopolymer and a resin and the second outer layer (E) contains a polymer mixture and an anti blocking agent.

The process for the production of the foldable multilayer polypropylene polymer film is as follows:
(a) Coextruding the melted materials of individual layers A, B, C, D, and E of the film through a die.
(b) Biaxially stretching the film at a machine and a transverse direction.
(c) Cooling down the biaxially stretched film.
(d) Corona treating the film
(e) Winding the film up.

The detailed description of the preferred embodiment has been explained below.

The present invention comprises a high barrier, foldable, polypropylene based biaxially oriented multilayer film for packaging the food specifically the margarine, butter or the like.

The earlier studies on the invention of biaxially oriented polypropylene packaging materials for twist packaging of foods have shown that twist characteristics have been obtained by the resins. However it has been stated that the resin migration is possible into the fat containing foods and this property is an undesirable one for packaging of foods.

Papers are customarily used as the material for packaging the margarine, butter or the like. The materials used for the packaging of such products cover the exterior sides of and are turned (folded) and glued to the short sides in order to bond the covering material and form the pack. The material selected for the covering material for packaging must be a material which can be readily formed as well as a material which can be handled in fast moving packaging equipment for the packaging of foods specifically margarine, butter or the like.

An offered A/B/C/D/E multilayer film of the present invention is biaxially oriented foldable propylene based film which comprises between one to five layers, preferably five layers, and a thickness of 20-120 μm, preferably from about 40 to 100 μm, more preferably 70 to 90 μm. The five layer film has the following compositional characteristics. The base layer (C) comprises between about 65% and about 85% by weight of polypropylene, more preferably from about 70% to 80% by weight, between about 5% to about 30% by weight of high performance resin, more preferably from about 10% to about 20% by weight, and about 5% to about 15% by weight of filler, more preferably less than about 10% by weight, such as calcium carbonate or talc in a polypropylene carrier (preferably containing between about 50% and about 70% by weight of calcium carbonate or talc between about 30% and about 50% by weight of a polypropylene). The data in percent by weight relate to the total weight of polypropylene polymer, filler and resin. Polypropylene polymers with a melting point of 150° C. or above are preferred in the base layer. Particularly preferred resins are hydrocarbon resins. The resins having a softening point from 120 to 160° C. are particularly preferred.

The outer skin layer (A) comprises between about 75% and about 95% by weight of polypropylene, more preferably from about 80% to 90% by weight, between about 5% to about 20% by weight of high performance resin, more preferably from about 7% to about 15% by weight, about 0% to about 10% by weight of filler, more preferably less than about 5% by weight. The data in percent by weight relate to the total weight of polypropylene polymer, filler, and resin.

The inner layer (B) comprises between about 65% and about 85% by weight of polypropylene, more preferably from about 70% to 80% by weight, between about 5% to about 20% by weight of high performance resin, more preferably from about 10% to about 15% by weight, about 0 to about 10% by weight of filler, more preferably less than about 5% by weight and between about 5% to about 15% by weight of color concentrate. The data in percent by weight relate to the total weight of polypropylene polymer, filler, resin and color concentrate. Color concentrate preferably contains about 60% to about 80% by weight of TiO2 and between about 20% to about 40% by weight of polyolefin carrier. The preferred polyolefin is polypropylene.

The inner layer (D) comprises between about 75% and about 95% by weight of polypropylene, more preferably from about 80% to 90% by weight, between about 5% to about 25% by weight of high performance resin, more preferably from about 10% to about 15% by weight. The data in percent by weight relate to the total weight of polypropylene polymer, and resin.

The other outer layer (E) comprises between about 85% and about 95% by weight of copolymer of propylene and ethylene (preferably over 95% of the copolymer being propylene), between about 5% to about 15% by weight of terpolymer of ethylene, propylene and butylene (preferably over 85% by weight of the terpolymer being polypropylene), and between about 0.1% to about 1.5% by weight of antiblocking agent. The data in percent by weight relate to the total weight of copolymer, terpolymer, and antiblocking agent. Preferred antiblocking agents are inorganic additives such as silicon dioxide, calcium carbonate, aluminum silicate, magnesium silicate, calcium phosphate and the like and/or organic polymers such as polyamides, polyesters and the like. Preference is given to aluminum silicate.

The thickness of the outer and the inner layers is generally greater than 0.5 μm, preferably in the range from about 0.8 to 5 μm, more preferably 1 to 3 μm, where the outer and the inner layers on both sides of the base layer can have identical or different thicknesses.

The overall thickness of the single or multilayer polypropylene film according to the invention is between 20 to 120 μm. The base layer of the multilayer films makes up from about 75 to 96% of the overall film thickness.

The mixture of dosed materials to make the film layers are melted and fed to the co-extruders. The melts corresponding to the individual layers of the film are co-extruded through a flat die where the melt become the first necessary form for the further process. After that, it is passed over a chill roller, which tends to solidify film. Following the crystallization, the cast film is dried with blown air. The film is then oriented by stretching it in a longitudinal direction, characterized as the machine direction, and in transverse direction to arrive at a film which can be characterized in terms of orientation ratios in both longitudinal and transverse directions. To avoid shrink back, the film is annealed both after the machine and transverse directional orientations. Subsequently, the film is then cooled down and subjected to further surface treatment with electrical discharge (corona treatment) to achieve high surface tension for printability. The film is wounded on steel cores with suitable tension and contact pressure to achieve good roll quality.

Some examples of the preferred embodiment of this invention are given below.

### EXAMPLE 1

A/B/C/D/E structure five-layer film having an overall thickness of 80 μm was produced by coextrusion followed by biaxially stretching, setting and corona or flame treatment on one or both sides. The outer layer (A) had a thickness of 2 μm, the outer layer (E) had a thickness of1 μm and the inner layers (B & D) each had a thickness of 2 μm.

Base Layer C:

77.8% by weight of polypropylene

15% by weight of hydrocarbon resin having a softening point of 140° C. and an average molecular weight of 2000

7.2% by weight of calcium carbonate.

Outer Layer A:

85.5% by weight of polypropylene

10% by weight of hydrocarbon resin having a softening point of 140° C. and an average molecular weight of 2000

4.5% by weight of calcium carbonate.

Outer Layer E:

92% by weight of ethylene-propylene copolymer having 96.5% by weight of polypropylene

7.52% by weight of ethylene, propylene and butylene terpolymer having 85% by weight polypropylene.

0.48% by weight of aluminum silicate as an anti blocking agent.

Inner Layer B:

77.8% by weight of polypropylene

12.5% by weight of hydrocarbon resin having a softening point of 140° C. and an average molecular weight of 2000

2.2% by weight of calcium carbonate

7.5% by weight of coloring agent for opacity.

Inner Layer D:

87.5% by weight of polypropylene

12.5% by weight of hydrocarbon resin having a softening point of 140° C. and an average molecular weight of 2000.

The processing conditions, the overall composition and the properties of the film produced in this way are given below in Tables 1, 2 and 3 respectively. The test methods to determine the characteristics of the produced film are given in Table 3 together with the values found for the defined characteristics.

### EXAMPLE 2

The film with a thickness of 80 μm and A/C/E structure without (B) and (D) inner layers having the same components as in Example 1 repeated with the following changes:

Base Layer C:

77.6% by weight of polypropylene

15.5% by weight of hydrocarbon resin having a softening point of 140° C. and an average molecular weight of 2000

6.9% by weight of calcium carbonate.

Outer Layer A:

87.4% by weight of polypropylene

5% by weight of hydrocarbon resin having a softening point of 140° C. and an average molecular weight of 2000

3.6% by weight of calcium carbonate

4% by weight of coloring agent for opacity.

After biaxially stretching, setting and corona or flame treatment in the given conditions (Table 1) 4 μm/75 μm/1 μm film prepared has composition and properties showing in Tables 2 and 3 respectively.

### EXAMPLE 3

The film with a thickness of 80 μm and C structure without (A) and (E) outer layers and (B) and (D) inner layers having the same components as in Example 1 repeated with the following changes:

Base Layer C:

78.4% by weight of polypropylene

14.5% by weight of hydrocarbon resin having a softening point of 140° C. and an average molecular weight of 2000

6.6% by weight of calcium carbonate

0.2% by weight of coloring agent for opacity

0.29% by weight of ethylene, propylene and butylene terpolymer

0.01% by weight of aluminum silicate as an anti blocking agent.

After biaxially stretching, setting and corona or flame treatment in the given conditions (Table 1) 80 μm film prepared has composition showing in Table 2.

TABLE 1
Processing Conditions

| | Example | | |
|---|---|---|---|
| Parameter | 1 | 2 | 3 |
| Extrusion Temperature of Layer A | 250° C. | 250° C. | |
| Extrusion Temperature of Layer B | 250° C. | | |
| Extrusion Temperature of Layer C | 250° C. | 250° C. | 250° C. |
| Extrusion Temperature of Layer D | 250° C. | | |
| Extrusion Temperature of Layer E | 230° C. | 230° C. | |
| Longitudinal stretching ratio | 4.5 | 4.5 | 4.5 |
| Longitudinal stretching temperature | 135° C. | 135° C. | 135° C. |
| Transverse stretching ratio | 9 | 9 | 9 |
| Transverse stretching temperature | 175° C. | 175° C. | 175° C. |
| Setting temperature | 165° C. | 165° C. | 165° C. |
| Corona treatment Voltage | 20 kV | 20 kV | 20 kV |
| Frequency | 25 kHz | 25 kHz | 25 khz |

TABLE 2
Overall Composition of the Films

| | Overall Composition of Films | | |
|---|---|---|---|
| | (%) | | |
| Components | E1 | E2 | E3 |
| Polypropylene | 77.27 | 77.12 | 78.4 |
| Propylene-Ethylene Copolymer | 1.15 | 1.15 | — |
| Ethylene-Propylene-Butylene Terpolymer | 0.094 | 0.094 | 0.29 |
| Resin | 14.56 | 14.78 | 14.5 |
| Calcium carbonate | 6.74 | 6.65 | 6.6 |
| Coloring agent | 0.188 | 0.2 | 0.2 |
| Aluminum silicate | 0.006 | 0.006 | 0.01 |

TABLE 3
Properties of the multilayer films

| Properties | Method | | E1 | E2 |
|---|---|---|---|---|
| Thickness (μm) | ASTM D374 | | 81.3 | 80.2 |
| Density (g/cm³) | | | 0.58 | 0.60 |
| Tensile strength | ASTM D882 | MD | 49 | 50 |
| (N/mm2) | | TD | 95 | 100 |
| Elongation at break (%) | ASTM D882 | MD | 111 | 121 |
| | | TD | 34 | 38 |
| Thermal shrinkage (%) | ASTM D2732 | MD | 3 | 3 |
| | | TD | 1 | 1 |
| Coefficient of Friction | ASTM D1894 | | 0.30 | 0.30 |
| Opacity (%) | DIN 53146 | | 82.5 | 81.6 |
| Gloss (45° C.) (%) | ASTM D2457 | Layer E/ | 90/ | 91/ |
| | | Layer A | 64 | 72 |
| Total light transmittance | ASTM D1746 | | 19 | 18 |
| (%) | | | | |
| Surface tension | ASTM D2578 | | 41 | 41 |
| (Dyne/cm) | | | | |
| Oxygen permeability | DIN 53380 | | 400.5 | 399.2 |
| 23° C. (ml/m² gün · atm) | | | | |
| Water vapor transmission | ASTM | | 2.42 | 2.41 |
| rate 37.8° C.; %90 RH | D895-79 | | | |
| (g/m² gün · atm) | | | | |

1- a single (C) or multilayer film (A/B/C/D/E), having improved barrier and grease impermeability, dead fold properties and also taking the various geometric shapes by packing machines, and characterized by comprising a base layer (C), an outer layer (A), an inner layer (B), and a second inner layer (D) consisting essentially of polypropylene polymer and a hydrocarbon resin, and a second outer layer (E) consisting of polypropylene polymer and an antiblocking agent:

2- The film as claimed in claim 1, and characterized by the polymer of the layers A, B, C, and D is a polypropylene homopolymer.

3- The film as claimed in claim 1, and characterized by the polymer of the layer E is selected from the group of consisting of
a copolymer of ethylene and propylene and a terpolymer of ethylene, propylene and butylenes

4- The layer as claimed in claim 3, wherein over about 95% by weight of copolymer is polypropylene.

5- The layer as claimed in claim 3, wherein over about 85% by weight of terpolymer is polypropylene.

6- The film as claimed in claim 1, and characterized by the film comprises a hydrocarbon resin from about 1% to 60% by weight, based on the total weight of the film.

7- The film as claimed in claim 1, and characterized by the base layer comprises from about 5% to 50% by weight of hydrocarbon resin, based on the weight of the base layer.

8- The film as claimed in claim 1, and characterized by the layers A, B, and D comprise from about 5% to 20% by weight of hydrocarbon resin, based on the weight of each layer.

9- The resin as claimed in claims 7 and 8, wherein more than 85% of said resin, by weight, based on the total weight of resin, has an average molecular weight from about 1500 to 2500, more preferably from about 1750 to 2250.

10- The film as claimed in claim 1, and characterized by the layers A, B and C comprise from about 3% to 30% by weight of filler.

11- The layers as claimed in claim 10, wherein said filler is selected from the group of consisting of calcium carbonate or talc in a polypropylene carrier.

12- The layers as claimed in claim 10, wherein said filler is between about 50% and about 70% by weight of calcium carbonate or talc, between about 30% and about 50% by weight of a polypropylene.

13- The film as claimed in claim 1, wherein the layer B comprises from about 5% to 15% by weight of color concentrate.

14- The layer as claimed in claim 13, wherein said color concentrate is between about 60% to 80% by weight of TiO2 and between about 20% to 40% by weight of polypropylene carrier.

15- The film as claimed in claim 1, wherein the layer E comprises from about 0.1% to 1.5% by weight of antiblocking agent, based on the total weight of the said layer.

16- The film as claimed in claim 1, wherein said antiblocking agent is selected from inorganic additives such as silicon dioxide, calcium carbonate, magnesium silicate, aluminum silicate, calcium phosphate and the like and/or organic polymers such as polyamides, polyesters and the like.

17- The film as claimed in claim 1, wherein the base layer (C) has a thickness of 60 to 80 μm.

18- The film as claimed in claim 1, wherein the each of the layers A, B, D, and E has a thickness less than 5 μm.

19- The film as claimed in claim 1, wherein the film is used for packaging food, more specifically the margarine, butter or the like.

20- The film as claimed in claims 1, 17 or 19, and characterized by its base layer (C) comprises between about 65% and about 85% by weight of polypropylene, more preferably from about 70% to 80% by weight.

21- The film as claimed in claims 1, 17, 19 or 20 and characterized by the polypropylene polymers in the base layer (C) preferably with a melting point of 150° C. or above.
